(19) United States
(12) Patent Application Publication
(10) Pub. No.: US 2012/0082371 A1
(43) Pub. Date: Apr. 5, 2012

(54) LABEL EMBEDDING TREES FOR MULTI-CLASS TASKS

(75) Inventors: Samy Bengio, Mountain View, CA (US); Jason E. Weston, New York, NY (US)

(73) Assignee: GOOGLE INC., Mountain View, CA (US)

(21) Appl. No.: 12/896,318

(22) Filed: Oct. 1, 2010

(51) Int. Cl. G06K 9/62

(52) U.S. Cl. 382/159

(57) ABSTRACT

Methods, systems, and apparatus, including computer programs encoded on a computer storage medium, for label embedding trees for large multi-class tasks. In one aspect, a method includes mapping each image in a plurality of images and each label in a plurality of labels into a multi-dimensional label embedding space. A tree of label predictors is trained with the plurality of mapped images such that an error function is minimized in which the error function counts an error for each mapped image if any of the label predictors at any depth of the tree incorrectly predicts that the mapped image belongs to the label predictor's respective label set.

### BACKGROUND

This specification relates to digital data processing and, in particular, to image classification.

Datasets available for prediction tasks are growing over time, resulting in increasing scale in all their measurable dimensions: separate from the issue of the growing number of examples m and features d, they are also growing in the number of classes k. Typical multi-class applications such as web advertising, textual document categorization, or image annotation have tens or hundreds of thousands of classes, and these datasets are still growing. This evolution is challenging traditional approaches where test time grows at least linearly with k.

At training time, a practical constraint is that learning should be feasible, i.e., it should not take more than a few days and must work with the memory and disk space requirements of the available hardware. Typical algorithms' training time linearly increases with m, d and k; algorithms that are quadratic or worse with respect to m or d are usually discarded by practitioners working on large scale tasks. At testing time, depending on the application, very specific time constraints may be necessary, usually measured in milliseconds, for example when a real-time response is required or a large number of records need to be processed. Moreover, memory usage restrictions may also apply.

### SUMMARY

In general, one innovative aspect of the subject matter described in this specification can be embodied in methods that include the actions of mapping each image in a plurality of images and each label in a plurality of labels into a multi-dimensional label embedding space, in which a mapped image has a greater similarity to a mapped label that is the particular mapped image's true label than to other mapped labels in the label embedding space; identifying a tree with a plurality of nodes and a plurality of edges which are ordered pairs of parent and child nodes, in which each node represents a label predictor for a respective label set, and in which a label set of a root node of the tree encompasses the plurality of mapped labels and each respective child node label set is a subset of the respective label set of the child's parent node; and training the label predictors in the tree with the plurality of mapped images such that an error function is minimized in which the error function counts an error for each mapped image in the plurality of mapped images if any of the label predictors at any depth of the tree incorrectly predicts that the mapped image belongs to the label predictor's respective label set. Other embodiments of this aspect include corresponding systems, apparatus, and computer programs, configured to perform the actions of the methods, encoded on computer storage devices.

These and other implementations can each optionally include one or more of the following features. The error function counts an error by checking, out of all the label predictors that have a common parent, if the label predictor whose respective label set contains the true label for the particular mapped image produces a highest score for the mapped image. The tree is used to classify a first image. Classifying the first image can comprise mapping the first image to the label embedding space. Some implementations learn one or more mappings into the label embedding space for each image in the plurality of images and each label in the plurality of labels. The similarity is based on a Euclidian distance between a position of the particular mapped image in the label embedding space and a position of the mapped label that is the particular mapped image's true label in the label embedding space. Each image in the plurality of images has a respective representation in a first multi-dimensional space and in which the label embedding space has a lower dimensionality than the first space.

Particular embodiments of the subject matter described in this specification can be implemented so as to realize one or more of the following advantages. Aspects of the subject matter provide a fast classification applicable to very large multi-class tasks. One aspect is a technique for learning label trees by (approximately) optimizing the overall tree loss using a joint convex problem over all nodes to learn the label predictors and a graph-cut optimization that minimizes the confusion between nodes to learn the tree structure. Another aspect is a supervised approach to label embedding that can be combined with the technique of learning label trees to yield label embedding trees. The techniques described herein can provide orders of magnitude speed-up compared to flat structures such as One-vs-Rest while yielding as good, or better accuracy, and they can outperform other tree-based or embedding approaches. In other words, these techniques make real-time inference feasible for very large multi-class tasks such as web advertising, document categorization, and image annotation.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flowchart of an example technique for training label predictors.

FIG. 2 is a schematic diagram of an example system configured to merge search results.

Like reference numbers and designations in the various drawings indicate like elements.

### DETAILED DESCRIPTION

In various implementations, algorithms are described that can have a classification speed sublinear at testing time in k as well as having limited dependence on d with overall complexity O(dₑk) with dₑ<<d and dₑ<<k with no loss in accuracy compared to methods that are O(kd). Moreover, memory consumption can be reduced from O(kd) to O(dₑk). An algorithm for learning a label tree is described in which each node makes a prediction of the subset of labels to be considered by its children, thus decreasing the number of labels k at a logarithmic rate until a prediction is reached. An algorithm is described that both learns the sets of labels at each node and the predictors at the nodes to optimize the overall tree loss. A predictor can be implemented with a support vector machine, for example. This approach can be superior to existing tree-based approaches which typically lose accuracy compared to O(kd) approaches. Label trees have O(d log k) complexity as the label predictor at each node is still linear in d. In various implementations, an embedding of the labels in a space typically of dimension dₑ is learned in order to optimize the overall tree loss. Various implementations (1) map a test example in the label embedding space with cost O(ddₑ) and then (2) predict using the label tree resulting in an overall cost O(dₑ(log k+d)). The label embedding approach can outperform other recently proposed label embedding approaches such as compressed sensing.

According to various implementations, each dimension of the label embedding space is defined by a real valued axis. Within the label embedding space, semantically similar items (e.g., images and their true labels) are automatically located in close proximity to each other without regard to the type of each item. In an implementation, the location of an item x in the label embedding space may be specified as a vector of real numbers specifying the location of item x in each of D dimensions of the space. Increasing the dimensionality of the label embedding space can improve the accuracy of the associations between embedded items. A high-dimensional label embedding space can represent a large training database, such as a training database acquired from web-accessible sources, with higher accuracy than a low-dimensional label embedding space. However, higher dimensionality also increases the computation complexity. Therefore, the number of dimensions can be determined based upon factors such as the size of the available training database, required accuracy level, and computational time. Defining label embedding space based upon real-valued axis increases the accuracy level of associations, because a substantially continuous mapping space can be maintained.

In various implementations, a label tree is a tree T=(N, E, F, L) with n+l indexed nodes N={0, . . . n}, a set of edges E={(p₁, c₁), (P_{|E|}, C_{|E|})} which are ordered pairs of parent and child node indices, label predictors F={ƒ₁, . . . , ƒₙ} and label sets L={l₀, . . . lₙ} associated to each node. The root node is labeled with index 0. The edges E are such that all other nodes have one parent, but they can have an arbitrary number of children (but still in all cases |E|=n). The label sets indicate the set of labels to which a point should belong if it arrives at the given node, and progress from generic to specific along the tree, i.e., the root label set contains all classes |l₀|=k and each child label set is a subset of its parent label set with lₚ=∪_{(p,c)∈E}l_{c}. Techniques described herein differentiate between disjoint label trees where there are only k leaf nodes, one per class, and hence any two nodes i and j at the same depth cannot share any labels, lᵢ∩lⱼ={ }, and joint label trees that can have more than k leaf nodes.

In some implementations, images are represented by vectors of features. The number of features can be greater than the number of dimensions in the label embedding space, for instance. Each image is first segmented into several overlapping square blocks at various scales. Each block is then represented by the concatenation of color and edge features. Image features can include, but are not limited to, one or more of edges, corners, ridges, interest points, and color histograms. Feature extraction may be based on one or more known methods such as, but not limited to, Scale Invariant Feature Transform (SIFT) and Principal Component Analysis (PCA), for example. Such blocks are then used to represent each image as a bag of visual words, or a histogram of the number of times each dictionary visual word is present in the image, yielding vectors having over 200 non-zero values on average. An example representation of images is described in Grangier, D., & Bengio, S., “A discriminative kernel-based model to ran images from text queries,” Transactions on Pattern Analysis and Machine Intelligence, vol. 30, Issue 8, 2008, pp. 1371-1384.

Algorithm 1 Label Tree Prediction Algorithm

| | |
|---|---|
| Input: test example x, parameters T. | |
| Let s = 0. | -Start at the root node |
| repeat | |
| Let s = argmax_{{c:(s,c)εE}}f_{c}(x). | -Traverse to the most confident |
| | child. |
| until \|lₛ\| = 1 | -Until this uniquely defines a |
| | single label |
| Return lₛ. | |

Classifying an example (e.g., an image) with the label tree can be achieved in various implementations by applying Algorithm 1 (shown above). Prediction begins at the root node (s=0) and for each edge leading to a child (s, c) ∈E the score of the label predictor ƒ_{c}(x) which predicts whether the example x belongs to the set of labels l_{c} is calculated. One takes the most confident prediction, traverses to that child node, and then repeats the process. Classification is complete when one arrives at a node that identifies only a single label, which is the predicted class.

Instances of label trees have been used in the literature before with various methods for choosing the parameters (N, E, F, L). Due to the difficulty of learning, many methods make approximations such as a random choice of E and optimization of F that does not take into account the overall loss of the entire system leading to suboptimal performance. Aspects of the subject matter described herein provide an algorithm to learn these parameters to optimize the overall empirical loss (called the tree loss) as accurately as possible for a given tree size (speed).

In various implementations, the tree loss to be minimized is defined as:

$$\begin{matrix}R ( {f}_{tree} ) = \int I ( {f}_{tree} ( x ) \neq y ) d P ( x , y ) \\ = \int {max}_{i ∈ B ( x ) = \{ {b}_{1} ( x ) , … {b}_{D ( x )} ( x ) \}} I ( y ∉ {l}_{i} ) d P ( x , y )\end{matrix} \qquad ( 1 )$$

where I is the indicator function and

bⱼ(x)=arg max_{{c:(b}_{ⱼ₋₁}_{(x),c)∈E}}ƒ_{c}(x)

is the index of the winning (“best”) node at depth j, b₀(x)=0, and D(x) is the depth in the tree of the final prediction for x, i.e., the number of loops plus one of the repeat block when running Algorithm 1. The tree loss measures an intermediate loss of 1 for each prediction at each depth j of the label tree where the true label is not in the label set l_{b}_{ⱼ}₍ₓ₎, for example. The final loss for a single example is the max over these losses, because if any one of these classifiers makes a mistake then regardless of the other predictions the wrong class will still be predicted. Hence, any algorithm that attempts to optimize the overall tree loss should train all the nodes jointly with respect to this maximum.

What follows is a description of how to learn the parameters T of the label tree and how to minimize the tree loss for a given fixed tree (N, E and L are fixed: F is to be learned).

Learning with a Fixed Label Tree

If a fixed label tree N, E, L is chosen in advance, the goal is simply to minimize the tree loss (1) over the variables F, given training data {(xᵢ,yᵢ)}_{i=1, . . . , m}. In various implementations, a standard approach of minimizing the empirical loss over the data is followed, while regularizing the solution. Two algorithms for solving this problem are considered.

Relaxation 1: Independent Convex Problems

One procedure is to consider the following relaxation to this problem:

$${R}_{emp} ( {f}_{tree} ) = \frac{1}{m} {\sum }_{i = 1}^{m} {max}_{j ∈ B ( x )} I ( {y}_{i} ∉ {l}_{j} ) \leq \frac{1}{m} {\sum }_{i = 1}^{m} {\sum }_{j = 1}^{n} I ( sgn ( {f}_{j} ( {x}_{i} ) ) = {C}_{j} ( {y}_{i} ) )$$

where Cⱼ(y)=1 if y ∈lⱼ and −1 otherwise. The number of errors counted by the approximation cannot be less than the empirical tree loss Rₑₘₚ as when, for a particular example, the loss is zero for the approximation and it is also zero for Rₑₘₚ. However, the approximation can be much larger because of the sum.

One then further approximates this by replacing the indicator function with the hinge loss and choosing linear (or kernel) models of the form ƒᵢ(x)=wᵢ^{T}φ(x). This leaves the following convex problem: minimize

$${\sum }_{j = 1}^{n} ( γ {‖ {w}_{j} ‖}^{2} + \frac{1}{m} {\sum }_{i = 1}^{m} {ξ}_{ij} ) s . t . ∀ i , j , \{ \begin{matrix}{C}_{j} ( {y}_{i} ) {f}_{j} ( {x}_{i} ) \geq 1 - {ξ}_{ij} \\ {ξ}_{ij} \geq 0\end{matrix}$$

where there has been added a classical 2-norm regularizer controlled by the hyperparameter γ. In some implementations, this can be split into n independent convex problems because the hyperplanes wᵢ, i=1, . . . , n, do not interact in the objective function.

Relaxation 2: Tree Loss Optimization (Joint Convex Problem)

A tighter minimization of the tree loss is provided in the following:

$$\frac{1}{m} {\sum }_{i = 1}^{m} {ξ}_{i}^{α} \\ s . t . {f}_{r} ( {x}_{i} ) \geq {f}_{s} ( {x}_{i} ) - {ξ}_{i} , \\ ∀ r , s \text{:} {y}_{i} ∈ {l}_{r} ⋀ {y}_{i} ∉ {l}_{s} ⋀ ( ∃ p : ( p , r ) ∈ E ⋀ ( p , s ) ∈ E ) \qquad ( 2 )$$

ξ≧0,i=1, . . . ,m (3)

When α is close to zero, the shared slack variables simply count a single error if any of the predictions at any depth of the tree are incorrect; so this is very close to the true optimization of the tree loss. This is measured by checking, out of all of the nodes that share the same parent, if the one containing the true label in its label set is highest ranked. In some implementations, α is set to 1 and which yields a convex optimization problem. Nevertheless, unlike relaxation (1) the max is not approximated with a sum. Again, using the hinge loss and a 2-norm regularizer, the final optimization problem is:

$$γ {\sum }_{j = 1}^{n} {‖ {w}_{j} ‖}^{2} + \frac{1}{m} {\sum }_{i = 1}^{m} {ξ}_{i} \qquad ( 4 )$$

subject to constraints (2) and (3).

Learning Label Tree Structures

What was described above demonstrates how to optimize the label predictors F while the nodes N, edges E and label sets L, which specify the structure of the tree, are fixed in advance. However, in various implementations tree structures can be learned dependent on the prediction problem such that the overall tree loss is minimized. What follows is a description of an algorithm for learning the parameters N, E, and L, i.e., optimizing equation (1) with respect to these parameters.

Algorithm 2 Learning the Label Tree Structure

Train k One-vs-Rest classifiers f̅₁, . . . , f̅ₖ independently (no tree structure
is used).
Compute the confusion matrix C̅ᵢⱼ = |{(x, y₁) ε V:arg maxᵣ f̅ᵣ(x) = j}| on
validation set V.
For each internal node l of the tree, from root to leaf, partition its label set lₗ
between its children's label sets Lₗ = {l_{c}:c ε Nₗ}, where
Nₗ = {c ε N:(l, c) ε E} and ∪_{cεN}_{₁} l_{c} = lₗ, by maximizing:
${R}_{l} ( {L}_{l} ) = {\sum }_{c ∈ {N}_{l}} {\sum }_{{y}_{p} , {y}_{q} ∈ {l}_{c}} {A}_{pq} , where A = \frac{1}{2} ( \overline{C} + {\overline{C}}^{T} )$
is the symmetrized confusion matrix, subject to constraints preventing
trivial solutions, e.g. putting all labels in one set. This optimization problem
(including the appropriate constraints) is a graph cut problem and it can be
solved with standard spectral clustering, i.e. we use A as the affinity matrix
for step 1 of the algorithm in [21], and then apply all of its other steps (2-6).
Learn the parameters f of the tree by minimizing (4) subject to contstraints
(2) and (3).

Key to the generalization ability of a particular choice of tree structure is the learnability of the label sets 1. If some classes are often confused but are in different label sets the functions ƒ may not be easily learnable, and the overall tree loss will hence be poor.

For example for an image classification task, a decision in the tree between two label sets, one containing tiger and jaguar labels versus one containing frog and toad labels is presumably more learnable than (tiger, frog) vs. (jaguar, toad). This implies learned tree structures should be much better than random ones as in random trees this mixing is likely to happen when the number of classes is large.

A naive way of learning the tree would be to consider all possible tree structures in turn, optimize ƒₜᵣₑₑ using the techniques above and take the one with the smallest overall tree error, which is unfortunately clearly infeasible. The following describes an optimization strategy for disjoint label trees that approximates the intractable naive strategy (the techniques in the previous section were applicable to both joint and disjoint trees). Empirical tree loss can be rewritten as:

$${R}_{emp} ( {f}_{tree} ) = \frac{1}{m} {\sum }_{i = 1}^{m} {max}_{j} ( I ( {y}_{i} ∈ {l}_{j} ) {\sum }_{\overline{y} ∉ {l}_{j}} C ( {x}_{i} , \overline{y} ) )$$

where C(xᵢ, y̅)=/(ƒₜᵣₑₑ(xᵢ)= y̅) is the confusion of labeling example xᵢ (with true label yᵢ) with label y̅ instead. That is, the tree loss for a given example is equal to 1 if there is a node j in the tree containing the true label, a different node at the same depth can be predicted, leading to a final label prediction not in the label set of j.

Intuitively, the confusion of predicting node i instead of j comes about because of the class confusion between the labels y ∈lᵢ and the labels y̅ ∈lⱼ. Hence, to provide the smallest tree in various implementations, labels are grouped together into the same label set that are likely to be confused at test time. If the confusion matrix of a particular tree structure is not known, the class confusion matrix of a surrogate classifier with the supposition that the matrices will be highly correlated can be used. This motivates the proposed Algorithm 2 which recursively partitions the label set according to the confusion between labels, using One-vs-Rest as the surrogate classifier. The main idea is to choose label sets between which there is little confusion, which is a graph cut problem where standard spectral clustering can be applied. The objective function of spectral clustering penalizes unbalanced partitions, hence encouraging balanced trees. See, e.g., A. Y. Ng, M. I. Jordan, and Y Weiss. ON SPECTRAL CLUSTERING: ANALYSIS AND AN ALGORITHM, Advances in Neural Information Processing Systems, 2:849-856 (2002). The results described below show that learnt trees outperform random structures and can match the accuracy of not using a tree at all, while being orders of magnitude faster.

Label Embeddings

An orthogonal angle of attack of the solution of large multi-class problems is to employ shared representations for the labelings, which are termed label embeddings. Introducing the function φ_{E}(y)=(0, . . . , 0, 1, 0, . . . , 0) which is a k-dimensional vector with a 1 in the y^{th} position and 0 otherwise, the goal is to find a linear embedding ∈(y)=Vφ∈(y) where V is a dₑ×k matrix assuming that labels y ∈{1, . . . , k}. Without a tree structure, multi-class classification is then achieved with:

ƒ_{embed}(x)=arg max_{1=1, . . . ,k}S(Wx·Vφ_{∈}(i)) (5)

where W is a dₑ×d matrix of parameters and S( . , . ) is a measure of similarity, e.g., an inner product or negative Euclidean distance. This method, unlike label trees, is still linear with respect to k. However, it does have better behavior with respect to the feature dimension d, with O(dₑ(d+k)) testing time, compared to methods such as One-vs-Rest which is O(kd). If the embedding dimension dₑ is much smaller than d, this gives a significant saving.

There are several ways to train such models. For example, the method of compressed sensing has a similar form to (5), but the matrix V is not learnt but chosen randomly, and only W is learnt. In what follows, a description is provided of how to train such models so that the matrix V captures the semantic similarity between classes, which can improve generalization performance over random choices of V in an analogous way to the improvement of label trees over random trees. Subsequently, a description is provided of how to combine label embeddings with label trees to gain the advantages of both approaches.

Learning Label Embeddings (Without a Tree)

There are several possibilities for learning V and W.

Sequence of Convex Problems

In various implementations, the label embedding can be learned by solving a sequence of convex problems using the following method. First, train independent (convex) classifiers ƒᵢ(x) for each class 1, . . . , k and compute the k×k confusion matrix C̅ over the data (xᵢ, yᵢ). Then, find the label embedding vectors Vᵢ that minimize:

$${\sum }_{i , j = 1}^{k} {A}_{ij} {‖ {V}_{i} - {V}_{j} ‖}^{2} ,$$

where A=½( C̅+ C̅^{T}) is the symmetrized confusion matrix, Subject to the constraint V^{T}DV=I where Dᵢᵢ=Aᵢⱼ (to prevent trivial solutions) which is the same problem solved by Laplacian Eigenmaps. An embedding matrix V is then obtained where similar classes i and j should have small distance between their vectors Vᵢ and Vⱼ. All that remains is to learn the parameters if W of the model. To do this, a convex multi-class classifier is trained utilizing the label embedding V: minimize

$$γ {‖ W ‖}_{FRO} + \frac{1}{m} {\sum }_{i = 1}^{m} {ξ}_{i}$$

where ∥·∥_{FRO} is the Frobenius norm, subject to constraints:

∥Wxᵢ−Vφ(i)∥²≦∥Wxᵢ−Vφ(j)∥²+ξᵢ,∀j≠i ξᵢ≦0,i=1, . . . ,m. (6)

Note that the constraint (6) is linear since ∥Wxᵢ∥² can be multiplied out and subtracted from both sides. At test time, equation (5) can be employed with S(z,z′)=−∥z′∥.

Non-Convex Joint Optimization

In further implementations, another approach is to learn W and V jointly, which requires non-convex optimization. The following can be minimized:

$$γ {‖ W ‖}_{FRO} + \frac{1}{m} {\sum }_{i = 1}^{m} {ξ}_{i}$$

subject to (Wxᵢ)^{T}Vφ(i)≦(Wxᵢ)^{T}Vφ(j)=ξᵢ,∀j≠i

and ∥Vᵢ∥≦1, ξ≧0, i=1, . . . , m. This can be optimized using stochastic gradient descent (with randomly initialized weights). At test time equation (5) can be employed with S(z, z′)=z^{T}z′.

Learning Label Embedding Trees

The use of embeddings can be combined with label trees to obtain the advantages of both approaches, which is termed the label embedding tree. At test time, the resulting label embedding tree prediction is given in Algorithm 3. The label embedding tree has O(dₑ(d+log(k))) testing speed.

Algorithm 3 Label Embedding Tree Prediction Algorithm

| | |
|---|---|
| Input: test example x, parameters T. | |
| Compute z = Wx | - Cache prediction on example |
| Let s = 0. | - Start at the root node |
| repeat | - Traverse to the most |
| Let s = arg max_{{c:(s,c)εE}} f_{c}(x) = arg | confident child |
| max_{{c:(s,c)εE}} Z^{T} ε(c). | |

| | |
|---|---|
| until \|lₛ\| = 1 | - Until this uniquely defines a single label. |
| Return lₛ. | |

To learn the label predictors for a label embedding tree the following minimization problem is provided:

$$γ {‖ W ‖}_{FRO} + \frac{1}{m} {\sum }_{i = 1}^{m} {ξ}_{i}$$

subject to constraints:

(Wxᵢ)^{T}Vφ_{E}(r)≦(Wxᵢ)^{T}Vφ_{E}(s)−ξᵢ,∀r,s:yᵢ∈lᵣ [symbol] y_{i∉l}ₛ [symbol] (∃p:(p,r)∈E [symbol] (p,s)∈E)∥Vᵢ∥≦1,ξᵢ≧0,i=1, . . . ,m.

This is essentially a combination of the optimization problems described above. Learning the tree structure for these models can still be achieved using Algorithm 2.

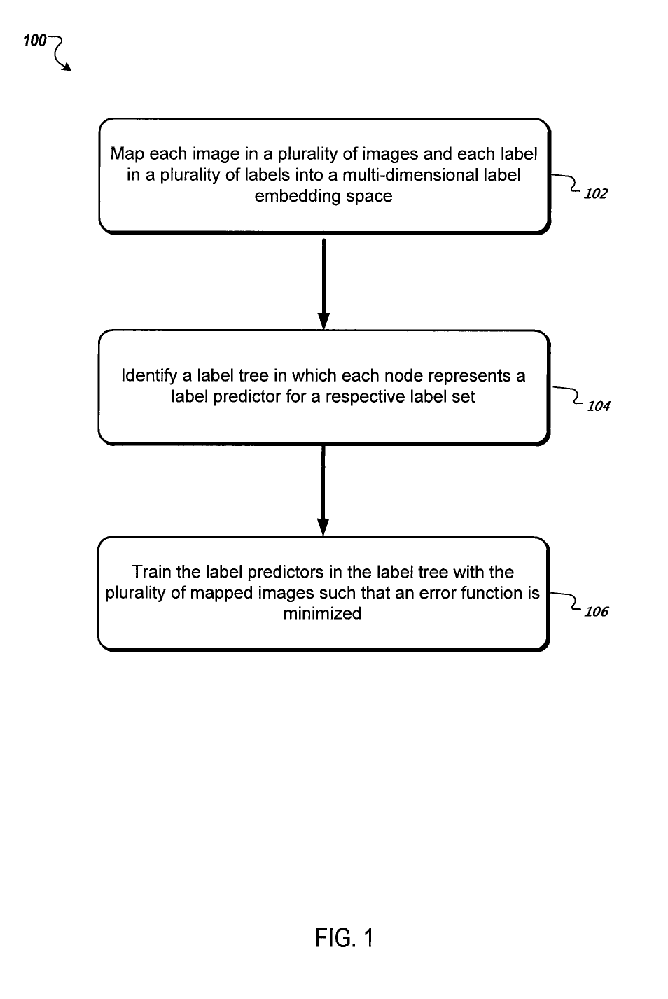

FIG. 1 is a flowchart of an example technique for training label predictors using the techniques described above. Each image xᵢ in a plurality of training images and each training image's associated label yᵢ is separately mapped to the multi-dimensional label embedding space (102). A mapped image has a greater similarity to a mapped label that is the particular mapped image's true label than to other mapped labels in the label embedding space. Next, a label embedding tree is identified (104). As described above, the label embedding tree can be predetermined or learned using Algorithm 2, for example. The label embedding tree has a plurality of nodes and a plurality of edges in which the edges are ordered pairs of parent and child nodes. Each node represents a label predictor for a respective label set. The root node's label set contains all classes |l₀|=k, and each child label set is a subset of its parent label set with lₚ=∪_{(p,c)∈E}l_{c}. Next the label predictors in the label embedding tree are trained (or “learned”) with the plurality of mapped images such that an error function is minimized (106). In various implementations, the error function counts an error for each mapped image in the plurality of mapped images if any of the label predictors at any depth of the tree incorrectly predicts that the mapped image belongs to the label predictor's respective label set. In some implementations, the error function counts an error by checking, out of all the label predictors that have a common parent, if the label predictor whose respective label set contains the true label for the particular mapped image produces a highest score for the mapped image. The resulting trained label tree can then be used to classify images using Algorithm 3, for example.

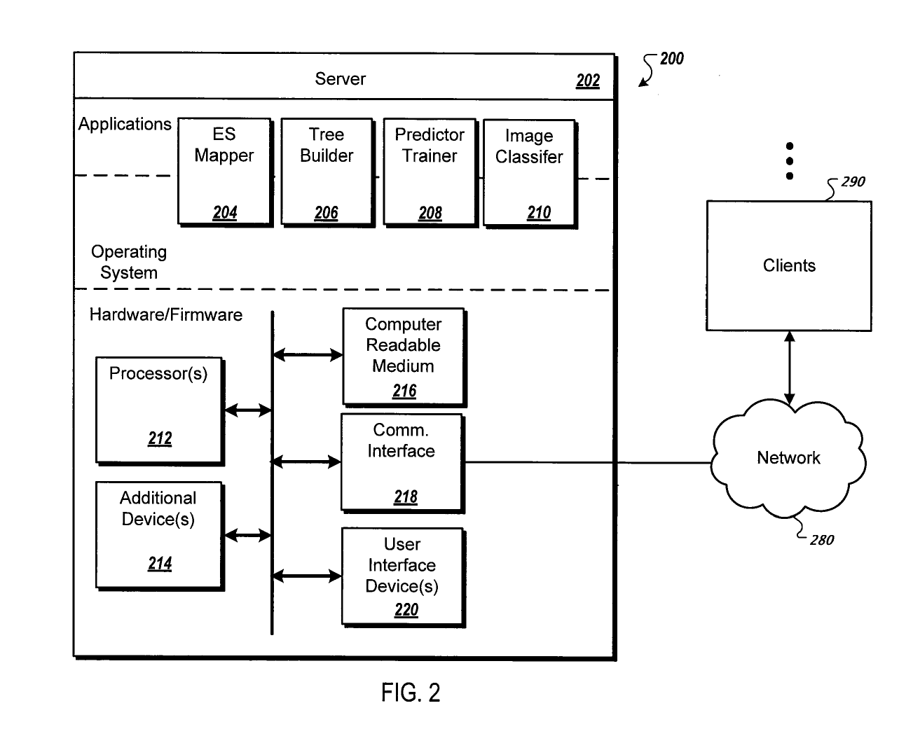

FIG. 2 is a schematic diagram of an example system configured to learn a label embedding tree and then classify images using the tree. The system 200 generally consists of a server 202. The server 202 is optionally connected to one or more user or client computers 290 through a network 280. The server 202 consists of one or more data processing apparatuses. While only one data processing apparatus is shown in FIG. 2, multiple data processing apparatuses can be used in one or more locations. The server 202 includes various modules, e.g., executable software programs, including an embedding space mapper 204 configured to map images and labels into an embedding space, a tree builder 206 configured to learn a label embedding tree, predictor trainer 208 configured to train the predictors in the label embedding tree, and an image classifier configured to use the trained label embedding tree to classify images. In some implementations, images to be classified are received from the client computers 290. For example, a user can take a picture with their smart phone and submit the resulting image as a query to the server 202.

Each module runs as part of the operating system on the server 202, runs as an application on the server 202, or runs as part of the operating system and part of an application on the server 202, for instance. Although several software modules are illustrated, there may be fewer or more software modules. Moreover, the software modules can be distributed on one or more data processing apparatus connected by one or more networks or other suitable communication mediums.

The server 202 also includes hardware or firmware devices including one or more processors 212, one or more additional devices 214, a computer readable medium 216, a communication interface 218, and one or more user interface devices 220. Each processor 212 is capable of processing instructions for execution within the server 202. In some implementations, the processor 212 is a single or multi-threaded processor. Each processor 212 is capable of processing instructions stored on the computer readable medium 216 or on a storage device such as one of the additional devices 214. The server 202 uses its communication interface 218 to communicate with one or more computers 290, for example, over a network 280. Examples of user interface devices 220 include a display, a camera, a speaker, a microphone, a tactile feedback device, a keyboard, and a mouse. The server 202 can store instructions that implement operations associated with the modules described above, for example, on the computer readable medium 216 or one or more additional devices 214, for example, one or more of a floppy disk device, a hard disk device, an optical disk device, or a tape device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
mapping each image in a plurality of images and each label in a plurality of labels into a multi-dimensional label embedding space, in which a mapped image has a greater similarity to a mapped label that is the particular mapped image's true label than to other mapped labels in the label embedding space;
identifying a tree with a plurality of nodes and a plurality of edges which are ordered pairs of parent and child nodes, in which each node represents a label predictor for a respective label set, and in which a label set of a root node of the tree encompasses the plurality of mapped labels and each respective child node label set is a subset of the respective label set of the child's parent node; and
training the label predictors in the tree with the plurality of mapped images such that an error function is minimized in which the error function counts an error for each mapped image in the plurality of mapped images if any of the label predictors at any depth of the tree incorrectly predicts that the mapped image belongs to the label predictor's respective label set.

2. The method of claim 1 in which the error function counts an error by checking, out of all the label predictors that have a common parent, if the label predictor whose respective label set contains the true label for the particular mapped image produces a highest score for the mapped image.

3. The method of claim 1, further comprising using the tree to classify a first image.

4. The method of claim 3 in which using the tree to classify the first image comprises mapping the first image to the label embedding space.

5. The method of claim 1, further comprising learning one or more mappings into the label embedding space for each image in the plurality of images and each label in the plurality of labels.

6. The method of claim 1 in which the similarity is based on a Euclidian distance between a position of the particular mapped image in the label embedding space and a position of the mapped label that is the particular mapped image's true label in the label embedding space.

7. The method of claim 1 in which each image in the plurality of images has a respective representation in a first multi-dimensional space and in which the label embedding space has a lower dimensionality than the first space.

8. A system comprising:
a storage medium including instructions; and
one or more data processing apparatuses operable to execute the instructions to perform operations comprising:
mapping each image in a plurality of images and each label in a plurality of labels into a multi-dimensional label embedding space, in which a mapped image has a greater similarity to a mapped label that is the particular mapped image's true label than to other mapped labels in the label embedding space;
identifying a tree with a plurality of nodes and a plurality of edges which are ordered pairs of parent and child nodes, in which each node represents a label predictor for a respective label set, and in which a label set of a root node of the tree encompasses the plurality of mapped labels and each respective child node label set is a subset of the respective label set of the child's parent node; and
training the label predictors in the tree with the plurality of mapped images such that an error function is minimized in which the error function counts an error for each mapped image in the plurality of mapped images if any of the label predictors at any depth of the tree incorrectly predicts that the mapped image belongs to the label predictor's respective label set.

9. The system of claim 8 in which the error function counts an error by checking, out of all the label predictors that have a common parent, if the label predictor whose respective label set contains the true label for the particular mapped image produces a highest score for the mapped image.

10. The system of claim 8, further including operations comprising using the tree to classify a first image.

11. The system of claim 10 in which using the tree to classify the first image comprises mapping the first image to the label embedding space.

12. The system of claim 8, further comprising learning one or more mappings into the label embedding space for each image in the plurality of images and each label in the plurality of labels.

13. The system of claim 8 in which the similarity is based on a Euclidian distance between a position of the particular mapped image in the label embedding space and a position of the mapped label that is the particular mapped image's true label in the label embedding space.

14. The system of claim 8 in which each image in the plurality of images has a respective representation in a first multi-dimensional space and in which the label embedding space has a lower dimensionality than the first space.

15. A computer storage medium encoded with a computer program, the program comprising instructions that when executed by data processing apparatus cause the data processing apparatus to perform operations comprising:
mapping each image in a plurality of images and each label in a plurality of labels into a multi-dimensional label embedding space, in which a mapped image has a greater similarity to a mapped label that is the particular mapped image's true label than to other mapped labels in the label embedding space;
identifying a tree with a plurality of nodes and a plurality of edges which are ordered pairs of parent and child nodes, in which each node represents a label predictor for a respective label set, and in which a label set of a root node of the tree encompasses the plurality of mapped labels and each respective child node label set is a subset of the respective label set of the child's parent node; and
training the label predictors in the tree with the plurality of mapped images such that an error function is minimized in which the error function counts an error for each mapped image in the plurality of mapped images if any of the label predictors at any depth of the tree incorrectly predicts that the mapped image belongs to the label predictor's respective label set.

16. The storage medium of claim 15 in which the error function counts an error by checking, out of all the label predictors that have a common parent, if the label predictor whose respective label set contains the true label for the particular mapped image produces a highest score for the mapped image.

17. The storage medium of claim 15, further including operations comprising using the tree to classify a first image.

18. The storage medium of claim 17 in which using the tree to classify the first image comprises mapping the first image to the label embedding space.

19. The storage medium of claim 15, further comprising learning one or more mappings into the label embedding space for each image in the plurality of images and each label in the plurality of labels.

20. The storage medium of claim 15 in which the similarity is based on a Euclidian distance between a position of the particular mapped image in the label embedding space and a position of the mapped label that is the particular mapped image's true label in the label embedding space.

21. The storage medium of claim 15 in which each image in the plurality of images has a respective representation in a first multi-dimensional space and in which the label embedding space has a lower dimensionality than the first space.
